(19) United States
(12) Patent Application Publication
(10) Pub. No.: US 2021/0285272 A1
(43) Pub. Date: Sep. 16, 2021

(54) HINGE MECHANISM WITH VARIOUS FRICTIONAL TORQUE

(71) Applicant: FOSITEK CORPORATION, New Taipei City (TW)

(72) Inventors: I-Hung CHIANG, New Taipei City (TW); Yung-Sheng KUO, New Taipei City (TW); Kai-Chun CHUNG, New Taipei City (TW)

(73) Assignee: FOSITEK CORPORATION, New Taipei City (TW)

(21) Appl. No.: 16/905,309

(22) Filed: Jun. 18, 2020

(30) Foreign Application Priority Data
Mar. 13, 2020 (TW) 109108336

(51) Int. Cl. E05D 11/08; G06F 1/16

(52) U.S. Cl. CPC E05D 11/087; G06F 1/1681; E05D 11/1078; G06F 1/1616; E05Y 2900/606

(57) ABSTRACT

A hinge mechanism includes a base gudgeon and a pivot pintle. The base gudgeon has a main body and first and second tubular portions formed on the main body and respectively having coaxial first and second pivot holes. The second tubular portion has a first torque regulating formation formed on an inner surrounding wall thereof. The pivot pintle has a first pintle section rotatably inserted into and pressed-fit to the first pivot hole to produce primary frictional torque during pivoting of the pivot pintle, a second pintle section rotatably inserted into and pressed-fit to the second pivot hole to produce secondary frictional torque, and a second torque regulating formation configured to be matingly engaged with the first torque regulating formation in a part of angular positions of the pivot pintle so as to reduce the secondary frictional torque.

### CROSS-REFERENCE TO RELATED APPLICATION

This application claims priority of Taiwanese Patent Application No. 109108336, filed on Mar. 13, 2020.

### FIELD

The disclosure relates to a hinge mechanism, and more particularly to a hinge mechanism with various frictional torque.

### BACKGROUND

Recently, friction torque hinges are widely utilized in a variety of foldable electronic products to provide a free-stop functionality between two elements to hold one element to a desired angular position relative to the other element with frictional torque. During the pivoting operation of the hinges, various frictional torque exerted on the elements for the same to reach different angular positions is of great advantages in the application. Moreover, when the frictional torque is higher, there is the price to pay for the durability, especially for a frequent usage.

### SUMMARY

Therefore, an object of the disclosure is to provide a hinge mechanism that can alleviate at least one of the drawbacks of the prior art.

According to the disclosure, the hinge mechanism includes a base gudgeon and a pivot pintle. The base gudgeon has a main body and first and second tubular portions which are formed on the main body and which are aligned with each other in a first direction. The first tubular portion has a first inner surrounding wall which surrounds a pivot axis in the first direction and which defines a first pivot hole therein. The second tubular portion has a second inner surrounding wall which surrounds the pivot axis and which defines a second pivot hole therein, and a first torque regulating formation which is formed on the second inner surrounding wall. The pivot pintle has a first pintle section which is rotatably inserted into the first pivot hole and which is pressed-fit to the first inner surrounding wall with a first frictional force, and a second pintle section which is rotatably inserted into the second pivot hole and which is pressed-fit to the second inner surrounding wall with a second frictional force. The second pintle section is formed with a second torque regulating formation which is configured to be matingly engageable with the first torque regulating formation in radial directions relative to the pivot axis such that the pivot pintle is pivotable relative to the base gudgeon about the pivot axis between an initial position and a delimited position, and such that, during the pivoting of the pivot pintle from one of the initial and delimited positions to the other one of the initial and delimited positions, in a part of angular positions, the second torque regulating formation is engaged with the first torque regulating formation to reduce the second frictional force.

### BRIEF DESCRIPTION OF THE DRAWINGS

Other features and advantages of the disclosure will become apparent in the following detailed description of the embodiment with reference to the accompanying drawings, of which:

FIG. 1 is a perspective view illustrating an embodiment of a hinge mechanism according to the disclosure;

FIG. 2 is a perspective view of the embodiment viewed from another angle;

FIG. 3 is an exploded perspective view of FIG. 1;

FIG. 4 is an exploded perspective view of FIG. 2;

FIG. 5 is a rear view of a base gudgeon of the embodiment;

FIG. 6 is a front view of the base gudgeon;

FIG. 7 is a top view of the embodiment illustrating a pivot pintle in an initial position;

FIG. 8 is a sectional view taken along line A-A of FIG. 7, illustrating the pivot pintle in the initial position;

FIG. 9 is a sectional view similar to FIG. 8, but illustrates the pivot pintle in a delimited position;

FIG. 10 is a sectional view taken along line B-B of FIG. 7, illustrating the pivot pintle in the initial position;

FIG. 11 is a sectional view similar to FIG. 10, but illustrates the pivot pintle in the delimited position;

FIG. 12 is a sectional view taken along line C-C of FIG. 7, illustrating the pivot pintle in the initial position; and

FIG. 13 is a sectional view similar to FIG. 12, but illustrates the pivot pintle in the delimited position.

### DETAILED DESCRIPTION

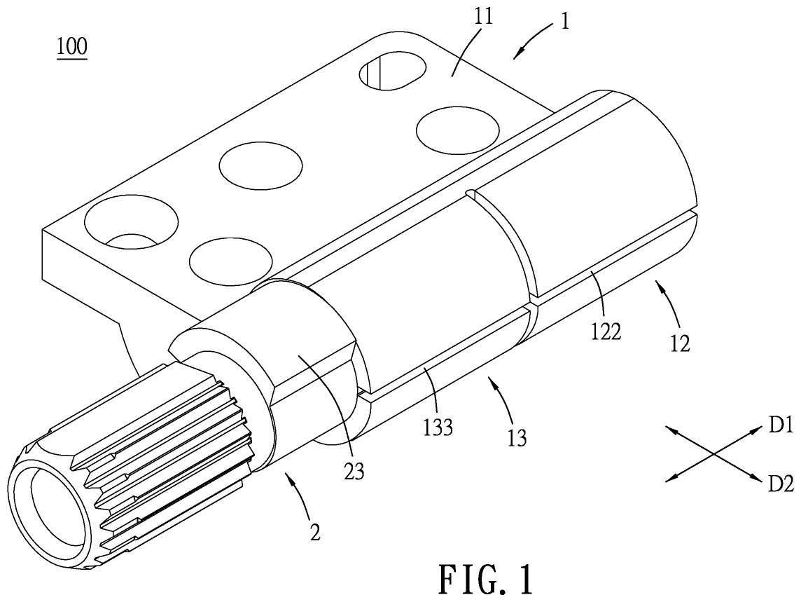

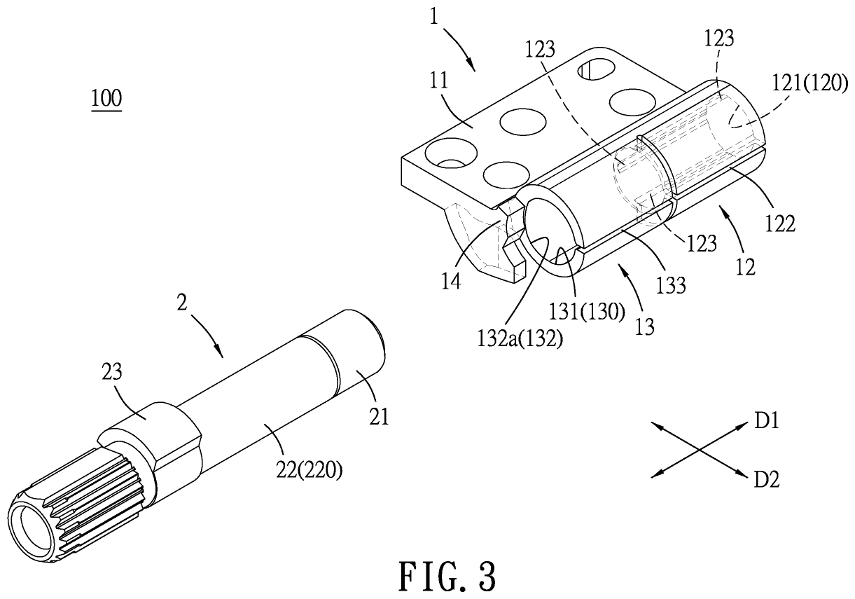

Referring to FIGS. 1 to 4, an embodiment of a hinge mechanism 100 according to the disclosure includes a base gudgeon 1 and a pivot pintle 2. For example, the base gudgeon 1 is connected to a first machine body (not shown) of an electronic device, and the pivot pintle 2 is connected to a second machine body (not shown) or another base seat (not shown).

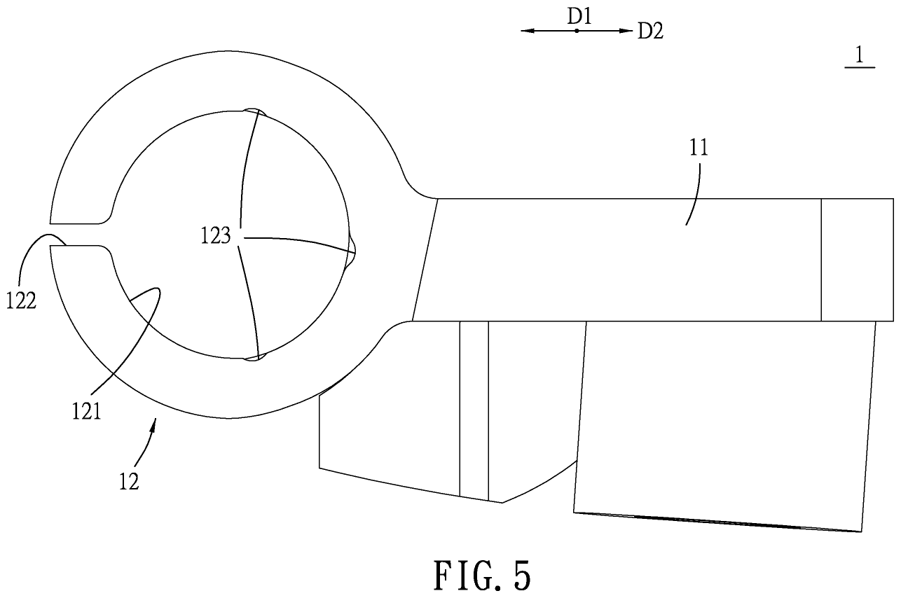

Referring to FIGS. 1 and 3 to 6, the base gudgeon 1 has a main body 11 and first and second tubular portions 12, 13 which are formed on the main body 11 and which are aligned with each other in a first direction (D1). The first and second tubular portions 12, 13 are of a cylindrical shape and extend in the first direction (D1) in this embodiment. The first tubular portion 12 has a first inner surrounding wall 120 which surrounds a pivot axis in the first direction (D1) and which defines a first pivot hole 121 therein. The second tubular portion 13 has a second inner surrounding wall 130 which surrounds the pivot axis and which defines a second pivot hole 131 therein, and a first torque regulating formation 132 which is formed on the second inner surrounding wall 130. In this embodiment, the first tubular portion 12 has a first split 122 which extends radially and in a second direction (D2) orthogonal to the first direction (D1) through the first inner surrounding wall 120 and which is elongated in the first direction (D1), and a plurality of slots 123 which are formed in the first inner surrounding wall 120 to be in spatial communication with the first pivot hole 121 and which are angularly spaced apart from each other about the pivot axis. Each of the slots 123 is elongated in the first direction (D1). The second tubular portion 13 has a second split 133 extending radially through the second inner surrounding wall 130 and elongated in the first direction (D1).

The pivot pintle 2 has a first pintle section 21 which is rotatably inserted into the first pivot hole 121 and which is pressed-fit to the first inner surrounding wall 120 with a first frictional force, and a second pintle section 22 which is rotatably inserted into the second pivot hole 131 and which is pressed-fit to the second inner surrounding wall 130 with a second frictional force. The second pintle section 22 is formed with a second torque regulating formation 221 which is configured to be matingly engageable with the first torque regulating formation 132 in radial directions relative to the pivot axis.

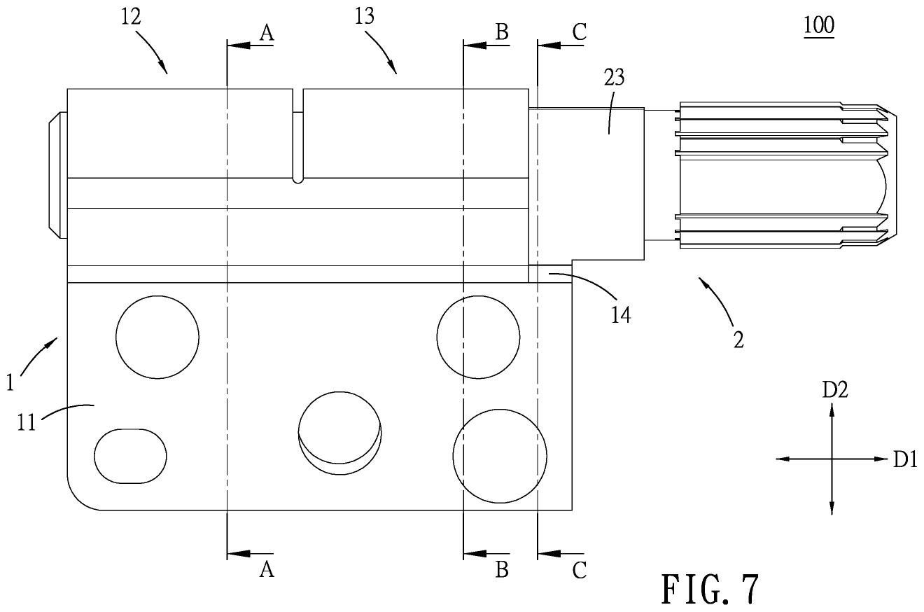

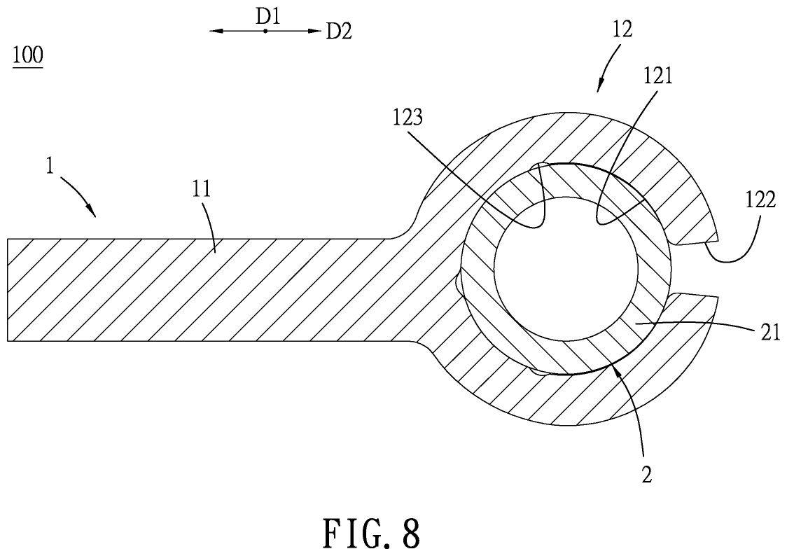

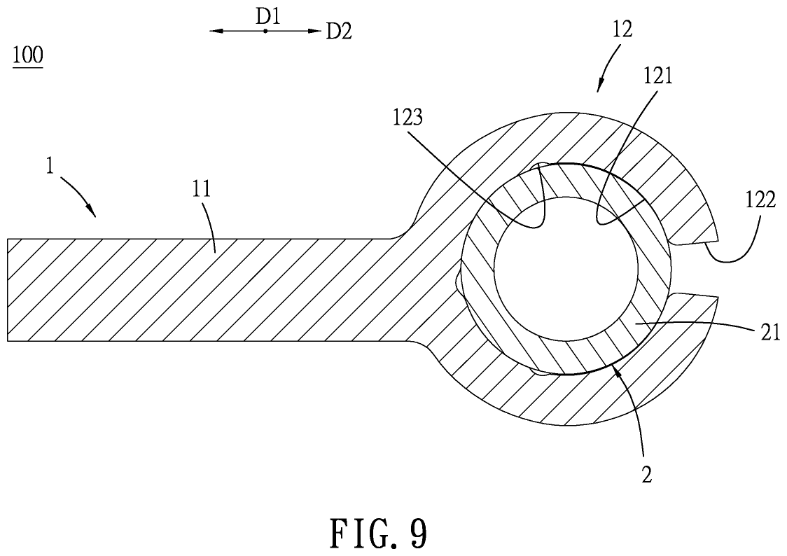

With reference to FIGS. 1, 3 and 7 to 9, the pivot pintle 2 is pivotable relative to the base gudgeon 1 about the pivot axis from an initial position (see FIG. 8) to a delimited position (see FIG. 9), or from the delimited position to the initial position. During the pivoting of the pivot pintle 2, the first pintle section 21 is pressed-fit to the first inner surrounding wall 120 with the first frictional force which provides primary frictional torque for holding the pivot pintle 2 at any desired angular position relative to the base gudgeon 1.

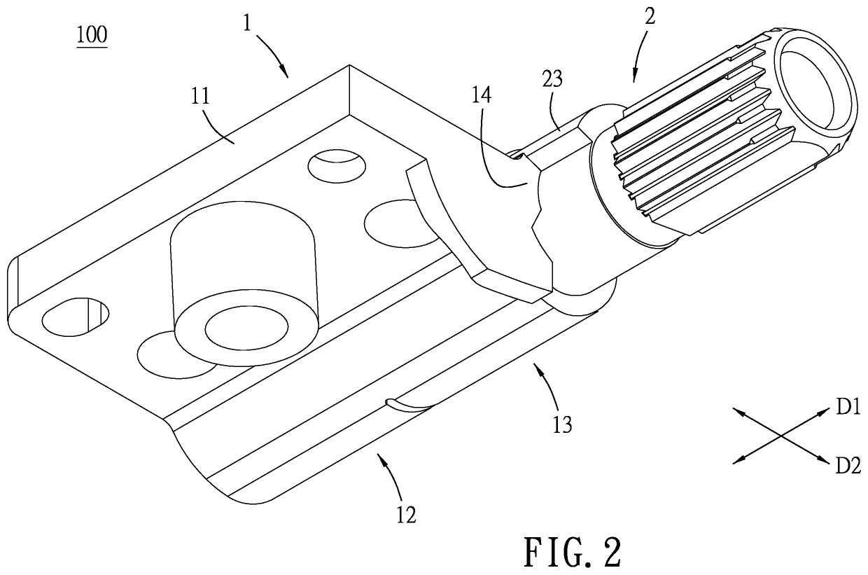

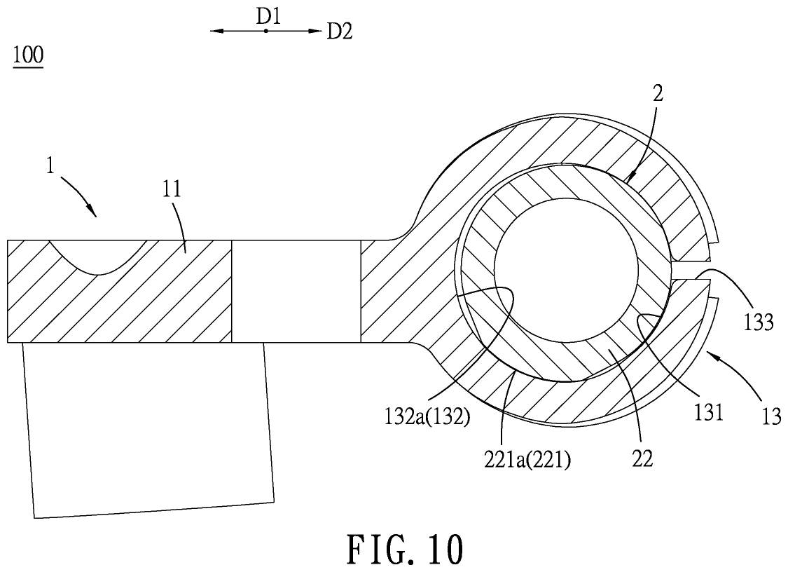

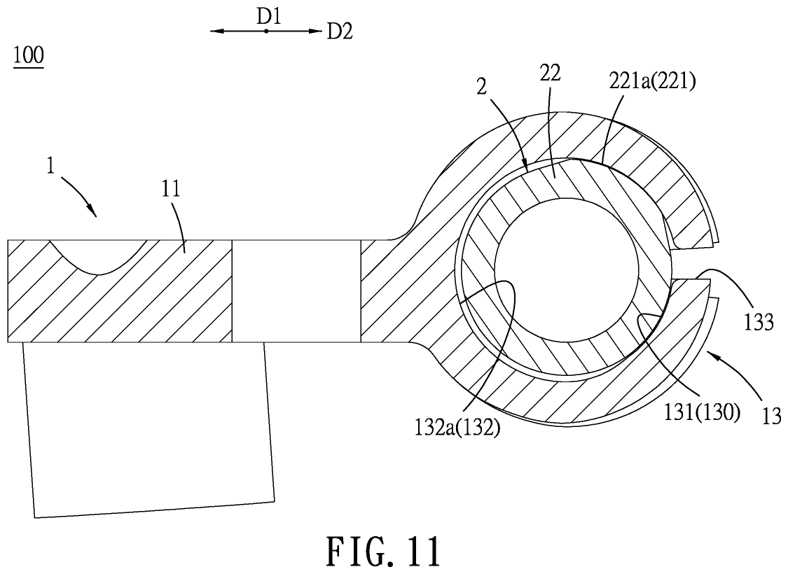

With reference to FIGS. 2, 4, 10 and 11, meanwhile, during the pivoting of the pivot pintle 2, in a part of the angular positions, for example, in the initial position, the second torque regulating formation 221 is engaged with the first torque regulating formation 132 to reduce the second frictional force. In other part of the angular positions, for example, in the delimited position, the second torque regulating formation 221 is disengaged from the first torque regulating formation 132 so as to keep the press-fit engagement with the second frictional force.

Specifically, in this embodiment, the first torque regulating formation 132 includes a recess (132a) which is formed in the second inner surrounding wall 130 and which extends in the first direction (D1). The second torque regulating formation 221 includes a protrusion (221a) which is formed on an outer surrounding wall 220 of the second pintle section 22 and which extends in the first direction (D1). During the pivoting of the pivot pintle 2, in the aforesaid part of the angular positions, the protrusion (221a) is received in the recess (132a) so as to bring the second pintle section 22 in loosely engagement with the second tubular portion 13 with a reduced second frictional force. In the aforesaid other part of the angular positions, the protrusion (221a) is disengaged from the recess (132a) and urges the second inner surrounding wall 130 of the second tubular portion 13 radially and outwardly to be pressed-fit thereto so as to produce increased frictional torque. It is noted that, alternatively, the recess and the protrusion may be formed in and on the outer surrounding wall 220 of the second pintle section 22 and the second inner surrounding wall 130 of the second tubular portion 13, respectively. Also, a plurality of the recesses and a plurality of the protrusions maybe formed to serve as the first and second torque regulating formations 132, 221.

With the first and second torque regulating formations 132, 221, various secondary frictional torque is provided between the second tubular portion 13 and the second pintle section 22 so as to raise the total frictional torque (that is the sum of the primary and secondary frictional torque) in a specified part of the angular positions of the pivot pintle 2. In this embodiment, when the pivot pintle 2 is in the aforesaid part of the angular positions in and adjacent to the initial position, the engagement between the first and second torque regulating formations 132, 221 results in the secondary frictional torque relatively smaller. Specifically, the protrusion (221a) is brought into engagement in the recess (132a) to reduce the second frictional force so as to release the press-fit engagement between the second pintle section 22 and the second inner surrounding wall 130. When the pivot pintle 2 is in the aforesaid other part of the angular positions in and adjacent to the delimited position, the second torque regulating formation 221, which has the protrusion (221a), is in frictional engagement with the second inner surrounding wall 130 so as to render the secondary frictional torque relatively larger. Alternatively, the first and second torque regulating formations 132, 221 maybe formed on the second tubular portion 13 and the second pintle section 22, respectively, at different positions from those described above in accordance with the requirement. Moreover, the number of the first tubular portion 12, the first pintle section 21, the second tubular portion 13 and the second pintle section 22 may be varied.

Specifically, in the prior art, a base gudgeon and a pivot pintle have one tubular portion and one pintle section to be rotatably engaged with each other with frictional torque so as to position the pivot pintle relative to the base gudgeon at any desired rotational position. It is also observed in the prior art that the base gudgeon and the pivot pintle have torque regulating formations formed on engaging wall surfaces of the tubular portion and the pintle section to provide various frictional torque during pivoting. However, such conventional torque regulating formations may cause flexible deformation of the tubular portion during pivoting, which results in reduction of the primary frictional torque and hence incurs deviation of a predetermined torque value. Moreover, a permanent deformation and wearing may further occur during frequent usage. In regard to this, in the present disclosure, the first tubular portion 12 and the first pintle section 21 are designed to provide primary frictional torque, and the second tubular portion 13 and the second pintle section 22 with the first and second torque regulating formations 132, 221 are designed to further provide secondary frictional torque (i.e. various frictional torque can be provided), such that undesired deformation of the inner surrounding wall 120 of the first tubular portion 12 hypothetically due to the first and second torque regulating formations 132, 221 can be avoided by having the first tubular portion 12 and the first pintle section 21 producing predetermined primary frictional torque. For this, excess flexible deformation and fatigue failure of the first and second tubular portions 12, 13 are also avoided, and stress concentration on the first and second torque regulating formations 132, 221 is prevented to avoid excessive wearing of the first and second torque regulating formations 132, 221.

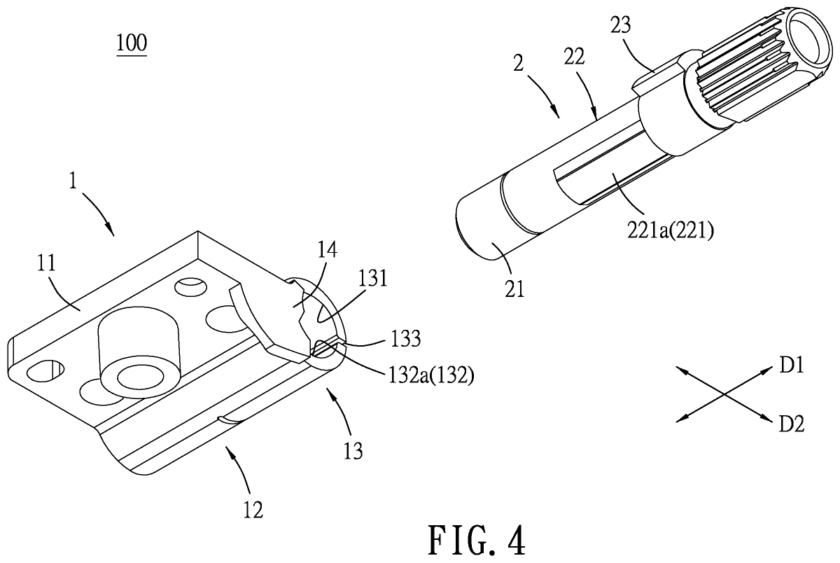

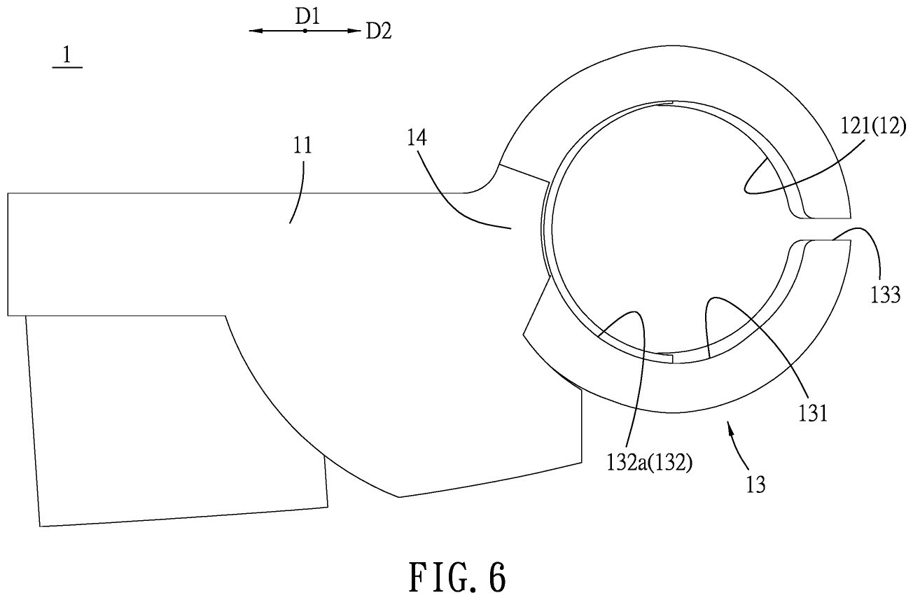

Referring to FIGS. 4, 6, 8 and 10, in this embodiment, an outer diameter of the first pintle section 21 is substantially the same as that of the second pintle section 22. An inner diameter of the second tubular portion 13 is substantially the same as the outer diameter of the second pintle section 22, while an inner diameter of the first tubular portion 12 is smaller than the inner diameter of the second tubular portion 13 (see FIG. 6) such that the first pintle section 21 is pressed-fit to and flexibly spread on the first inner surrounding wall 120 of the first tubular portion 12. Alternatively, in other modified embodiments, the inner diameters of the first and second tubular portions 12, 13 may be substantially the same, and the outer diameter of the first pintle section 21 is larger than that of the second pintle section 22. Additionally, the first split 122 vests the first tubular portion 12 with an increased radial flexibility for facilitating wrapping around the first pintle section 21. The second split 133 vests the second tubular portion 13 with an increased radial flexibility for facilitating wrapping around the second pintle section 22.

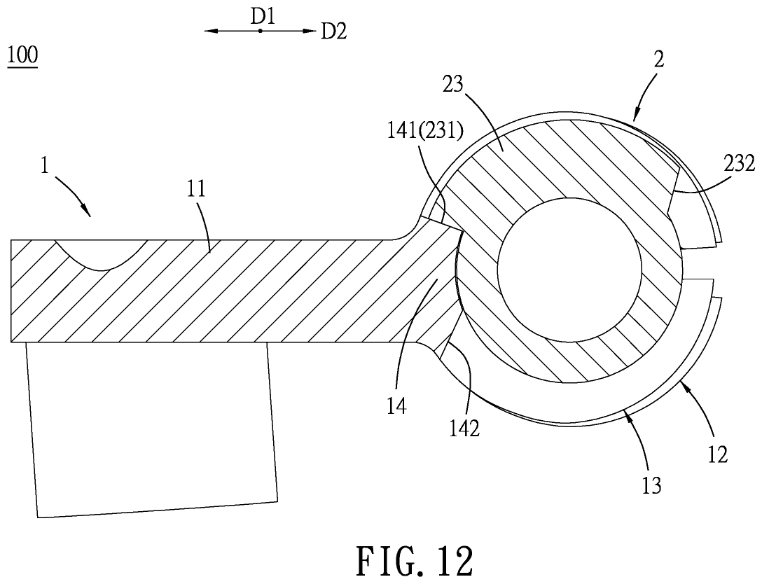

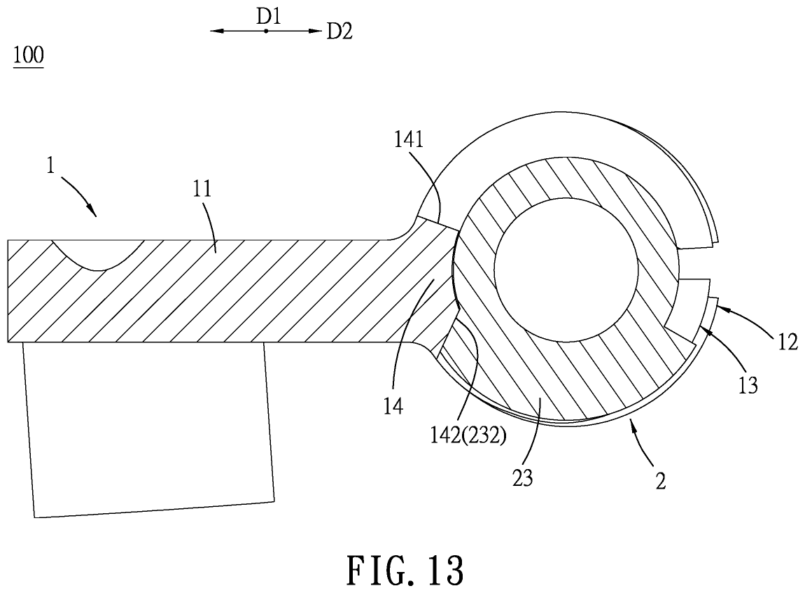

Referring to FIGS. 2, 4, 12 and 13, in this embodiment, the base gudgeon 1 further has a blocking portion 14 which is formed on the main body 11 and which has two first abutting surfaces 141, 142 opposite to each other along a circle around the pivot axis. The pivot pintle 2 further has a blocked section 23 which has two second abutting surfaces 231, 232 opposite to each other along the circle around the pivot axis. When the pivot pintle 2 is in the initial position, one second abutting surface 231 engages with one first abutting surface 141. When the pivot pintle 2 is in the delimited position, the other second abutting surface 232 engages with the other first abutting surface 142 so as to delimit the pivoting of the pivot pintle 2. It is noted that the base gudgeon 1 may have two blocking portions 14. In this case, when the pivot pintle 2 is in the initial position, the blocked section 23 abuts against one of the blocking portions 14. In the delimited position, the blocked section 23 abuts against the other blocking portion 14.

Referring to FIGS. 1 and 8, in this embodiment, the first and second pintle sections 21, 22 are hollow for weight reduction and material saving purposes. It is noted that the pivot pintle 2 may be a solid cylinder.

Referring to FIGS. 1 and 2, in this embodiment, the first and second tubular portions 12, 13 are partially connected to each other at a juncture adjacent to the main body 11 to form as a one-single piece so as to improve the structural strength of the base gudgeon 1. In a different embodiment, the first and second tubular portions 12, 13 may be formed as two separate parts.

As illustrated, with the first tubular portion 12 and the first pintle section 21 pressed-fit to each other, and the second tubular portion 13 and the second pintle section 22 having the first and second torque regulating formations 132, 221, primary frictional torque and secondary frictional torque are produced separately without interference with each other so as to generate predetermined frictional torque and prevent undesired permanent deformation of the base gudgeon 1 and excessive wearing of the first and second torque regulating formations 132, 221.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A hinge mechanism comprising:
a base gudgeon having a main body and first and second tubular portions which are formed on said main body and which are aligned with each other in a first direction, said first tubular portion having a first inner surrounding wall which surrounds a pivot axis in the first direction and which defines a first pivot hole therein, said second tubular portion having a second inner surrounding wall which surrounds the pivot axis and which defines a second pivot hole therein, and a first torque regulating formation which is formed on said second inner surrounding wall; and
a pivot pintle having a first pintle section which is rotatably inserted into said first pivot hole and which is pressed-fit to said first inner surrounding wall with a first frictional force, and a second pintle section which is rotatably inserted into said second pivot hole and which is pressed-fit to said second inner surrounding wall with a second frictional force, said second pintle section being formed with a second torque regulating formation which is configured to be matingly engageable with said first torque regulating formation in radial directions relative to the pivot axis such that said pivot pintle is pivotable relative to said base gudgeon about the pivot axis between an initial position and a delimited position, and such that, during the pivoting of said pivot pintle from one of the initial and delimited positions to the other one of the initial and delimited positions, in a part of angular positions, said second torque regulating formation is engaged with said first torque regulating formation to reduce the second frictional force.

2. The hinge mechanism as claimed in claim 1, wherein said first tubular portion of said base gudgeon has a first split extending radially through said first inner surrounding wall and elongated in the first direction so as to vest said first tubular portion with an increased radial flexibility for facilitating wrapping around said first pintle section, said second tubular portion of said base gudgeon having a second split extending radially through said second inner surrounding wall and elongated in the first direction so as to vest said second tubular portion with an increased radial flexibility for facilitating wrapping around said second pintle section.

3. The hinge mechanism as claimed in claim 1, wherein said first tubular portion of said base gudgeon has a plurality of slots which are formed in said first inner surrounding wall to be in spatial communication with said first pivot hole and which are angularly spaced apart from each other about the pivot axis, each of said slots being elongated in the first direction.

4. The hinge mechanism as claimed in claim 1, wherein one of said first and second torque regulating formations includes a recess which is formed in a corresponding one of said second inner surrounding wall of said second tubular portion and an outer surrounding wall of said second pintle section, and the other one of said first and second torque regulating formations includes a protrusion which is formed on a corresponding one of said second inner surrounding wall of said second tubular portion and an outer surrounding wall of said second pintle section such that, in the part of the angular positions, said protrusion is brought into engagement in said recess to reduce the second frictional force so as to release the press-fit engagement between said second pintle section and said second inner surrounding wall.

5. The hinge mechanism as claimed in claim 1, wherein said base gudgeon further has a blocking portion which is formed on said main body and which has two first abutting surfaces opposite to each other along a circle around the pivot axis, and said pivot pintle further has a blocked section which has two second abutting surfaces opposite to each other along the circle around the pivot axis such that one of said second abutting surfaces engages with one of said first abutting surfaces when said pivot pintle is in the initial position, and such that the other one of said second abutting surfaces engages with the other one of said first abutting surfaces when said pivot pintle is in the delimited position so as to delimit the pivoting of said pivot pintle.

6. The hinge mechanism as claimed in claim 1, wherein said first and second pintle sections are hollow.

7. The hinge mechanism as claimed in claim 1, wherein said first and second tubular portions are connected to each other at a juncture adjacent to said main body to form as a one-single piece.
